(19) United States
(12) Patent Application Publication
(10) Pub. No.: US 2013/0262489 A1
(43) Pub. Date: Oct. 3, 2013

(54) INFORMATION CONVERSION DEVICE AND INFORMATION SEARCH DEVICE

(71) Applicant: FUJITSU LIMITED, Kawasaki-shi (JP)

(72) Inventor: Shinichi SHIRAKAWA, Ichikawa (JP)

(21) Appl. No.: 13/718,146

(22) Filed: Dec. 18, 2012

(30) Foreign Application Priority Data
Mar. 28, 2012 (JP) 2012-075189

(51) Int. Cl. G06F 17/30

(52) U.S. Cl. CPC G06F 17/30424
USPC 707/756

(57) ABSTRACT

An information conversion device includes a memory and a processor coupled to the memory. The processor executes a process including converting a feature quantity vector of data which is a target of a search process using a Hamming distance into a symbol string including a binary symbol and a wild card symbol that causes a Hamming distance from the binary symbol to be zero (0).

### CROSS-REFERENCE TO RELATED APPLICATION

This application is based upon and claims the benefit of priority of the prior Japanese Patent Application No. 2012-075189, filed on Mar. 28, 2012, the entire contents of which are incorporated herein by reference.

### FIELD

The embodiments discussed herein are directed to an information conversion device, an information search device, an information conversion method, an information search method, and a computer-readable recording medium.

### BACKGROUND

In the past, there has been known a technique of searching for data in which a level of similarity or relevance with input query data satisfies a predetermined condition from among a plurality of pieces of data registered in a database. As an example of such a technique, there has been known a neighbor search technique in which a level of similarity or relevance between data and data is represented by a distance of a feature quantity vector in a multi-dimensional space, and a predetermined number of pieces of data are selected from data whose distance from query data is within a threshold value or data near to query data.

FIG. 12 is a diagram for describing a neighbor search according to a related art. For example, an information processing device that executes a neighbor search stores a feature quantity vector of data of a search target as indicated by a white circle in FIG. 12. Here, when query data indicated (A) in FIG. 12 is acquired, the information processing device calculates a distance between the query data and the feature quantity vector, and recognizes data whose distance from the query data is within a predetermined range as neighbor data of the query data as indicated by (B) in FIG. 12.

Here, in the case in which a number of pieces of data are registered in a database, if distances between all pieces of data and query data registered in the database are calculated, a computation cost for executing a neighbor search increases. In this regard, there has been known a technique in which a computation cost for executing a neighbor search is reduced such that data of a search target is limited using an index of a feature quantity vector space which is generated in advance or an index based on a distance form a specific feature quantity vector. However, in this technique, it is difficult to reduce a computation cost when a dimension number of a feature quantity vector increases.

In this regard, as a technique of reducing a computation cost in a search process, there has been known a technique of speeding up a search process such that stringency of a search result is mitigated, and then a set of similar data approximate to query data is acquired. For example, a match retrieval or a calculation of a Hamming distance between binary strings is performed at a higher speed than a calculation of a distance between vectors. In this regard, there has been known a technique of reducing a computation cost such that a feature quantity vector is converted into a binary string while maintaining a distance relation between feature quantity vectors, and a match retrieval or a Hamming distance with a binary string converted from query data is calculated.

Here, a technique of converting a feature quantity vector of a database into binary data by applying a random projection function has been known as a technique of converting a feature quantity vector into a binary string. In addition, there has been known a technique of deciding a projection function in which the distribution of data is considered using previously obtained registration data and converting a feature quantity vector into binary data through the decided projection function in order to perform conversion in a state in which a distance relation of original feature quantity vectors is maintained.

Next, an example of a method of converting a feature quantity vector into a binary string and searching for a data similar to query data will be described. FIG. 13 is a diagram for describing a search process based on binarization. An example illustrated in FIG. 13 will be described in connection with a method of converting a feature quantity vector indicated by a white circle in FIG. 13 into a two-digit binary string.

For example, an information processing device stores a feature quantity vector indicated by a white circle in FIG. 13. Here, the information processing device applies a projection function such that a first digit of a binary string is converted into “1” on a feature quantity vector included in a range above a dashed line in FIG. 13, and a first digit of a binary string is converted into “0” on a feature quantity vector included in a range below the dashed line. In addition, the information processing device converts a second digit of a binary string to “1” on a feature quantity vector included in a range at the right of a solid line in FIG. 13, and converts a second digit of a binary string to “0” on a feature quantity vector included in a range at the left of the solid line.

As a result, each feature quantity vector is converted into any of “01,” “11,” “00,” and “10.” Further, when a binary string converted from query data is “11” as indicated by (C) in FIG. 13, the information processing device sets a binary string in which a Hamming distance is “0,” that is, a feature quantity vector in which a binary string is “11” as neighbor data of query data.
Patent Document 1: Japanese Laid-open Patent Publication No. 2003-028935
Patent Document 2: Japanese Patent No. 2815045
Patent Document 3: Japanese Laid-open Patent Publication No. 2006-277407
Patent Document 4: Japanese Laid-open Patent Publication No. 2007-249339
Non-Patent Document 1: M. Datar, N. Immorlica, P. Indyk, V. S. Mirrokni: Locality-Sensitive Hashing Scheme Based on p-Stable Distributions, Proceedings of the twentieth annual symposium on Computational geometry (SCG) 2004
Non-Patent Document 2: Y. Weiss, A. Torralba, R. Fergus: Spectral Hashing, Advances in Neural Information Processing Systems (NIPS) 2008
Non-Patent Document 3: B. Kulis, T. Darrell: Learning to Hash with Binary Reconstructive Embeddings, Advances in Neural Information Processing Systems (NIPS) 2009
Non-Patent Document 4: Norouzi, D. Fleet: Minimal Loss Hashing for Compact Binary Codes, International Conference in Machine Learning (ICML) 2011

However, in the technique of converting a feature quantity vector into a binary string as described above, since one feature quantity vector is mapped with one binary string, a distance of a binary string on a similar feature quantity vector is increased, and thus there is a problem in that search omission may occur.

FIG. 14 is a diagram for describing a problem according to a related art. For example, when query data indicted by (D) in FIG. 14 is input, the information processing device extracts data of a feature quantity vector in which a binary string is “11” as indicated by a hatched line in the right portion of FIG. 14. However, the information processing device does not extract a feature quantity vector that is near the query data but does not have a binary string of “11” as indicated by a white circle on the right portion of FIG. 14. As a result, the information processing device causes search omission.

### SUMMARY

According to an aspect of an embodiment, an information conversion device includes a memory and a processor coupled to the memory. The processor executes a process including converting a feature quantity vector of data which is a target of a search process using a Hamming distance into a symbol string including a binary symbol and a wild card symbol that causes a Hamming distance from the binary symbol to be zero (0).

According to another aspect of an embodiment, an information search device includes a memory and a processor coupled to the memory. The processor executes a process including converting a feature quantity vector of data which is a target of a search process using a Hamming distance into a symbol string including a binary symbol and a wild card symbol that causes a Hamming distance from the binary symbol to be zero (0). The process includes searching data that causes a Hamming distance between a symbol string converted at the converting and a binary string converted from query data is a predetermined value or less from among the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing a functional configuration of an information search device according to a first embodiment;

FIG. 2 is a diagram for describing an example of biometric authentication;

FIG. 3 is a diagram for describing an example of information stored in the feature quantity vector storage unit;

FIG. 4 is a diagram for describing an example of information stored in the symbol string data index storage unit;

FIG. 5 is a diagram for describing a component which is converted into a wild card symbol by a conversion function;

FIG. 6 is a diagram for describing a process of updating a conversion function such that a distance relation between symbol strings is maintained;

FIG. 7 is a diagram for describing an example of a conversion function;

FIG. 8 is a diagram for describing a process of extracting a symbol string of a feature quantity vector serving as a neighbor candidate of query data;

FIG. 9 is a diagram for describing an example of a hash table stored in a search unit;

FIG. 10 is a flowchart for describing the flow of a process of generating a conversion function;

FIG. 11 is a diagram for describing an example of a computer that executes an information converting program;

FIG. 12 is a diagram for describing a neighbor search according to a related art;

FIG. 13 is a diagram for describing a search process based on binarization; and

FIG. 14 is a diagram for describing a problem according to a related art.

### DESCRIPTION OF EMBODIMENTS

Preferred embodiments of the present invention will be explained with reference to accompanying drawings.

### [a] First Embodiment

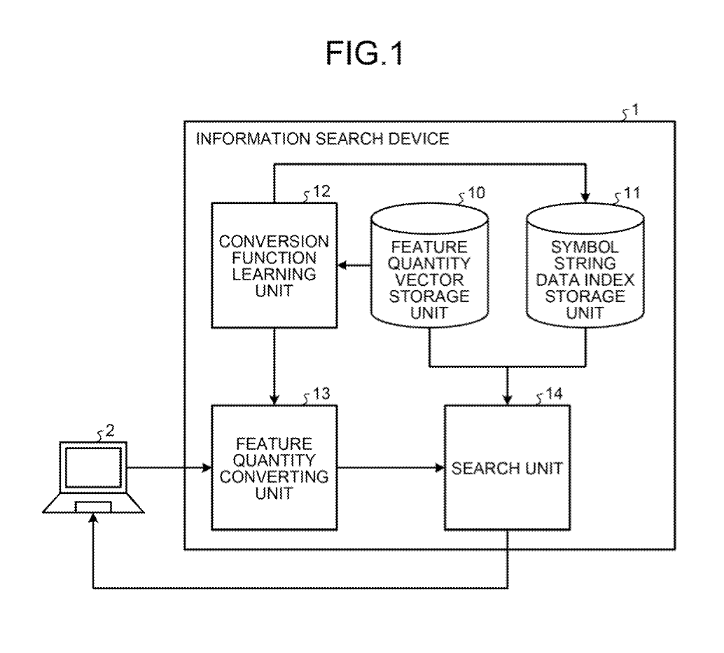

A first embodiment will be described below in connection with an information search device that searches for neighbor data of query data using a binarized feature quantity vector with reference to FIG. 1. FIG. 1 is a diagram for describing a functional configuration of an information search device according to the first embodiment. In an example illustrated in FIG. 1, an information search device 1 includes a feature quantity vector storage unit 10, a symbol string data index storage unit 11, a conversion function learning unit 12, a feature quantity converting unit 13, and a search unit 14.

In addition, the information search device 1 is connected with a client device 2 through which query data is input. Here, when query data is received from the client device 2, the information search device 1 searches for neighbor data of the received query data, and transmits the searched neighbor data to the client device 2. Here, the information search device 1 searches for data such as an image or a voice or biological data in biometric authentication using a fingerprint pattern or a vein pattern as a search target.

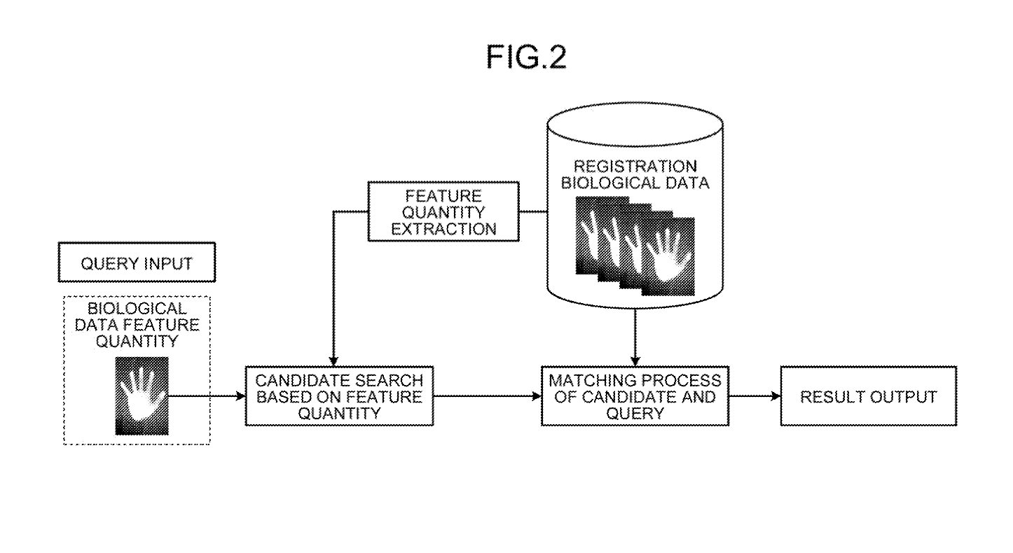

FIG. 2 is a diagram for describing an example of biometric authentication. An example illustrated in FIG. 2 represents a process in 1:N ID-less authentication in which information such as user ID (identification) is not input and narrowing-down of biological data of a search target is not performed. As illustrated in FIG. 2, the information search device 1 stores a plurality of pieces of registration biological data which are registered by a plurality of users.

Here, when biological data is input from the client device 2 as query data, the information search device 1 extracts a feature quantity vector representing a feature quantity of the input biological data, and searches for registration biological data having a feature quantity vector similar to the extracted feature quantity vector. In other words, the information search device 1 determines whether or not registration biological data of the user who has input the query data remains registered.

Further, the information search device 1 calculates a Hamming distance between a symbol string converted from the feature quantity vector of the registration biological data and a symbol string obtained by binarizing a feature quantity vector in the biological data input as the query data. Then, the information search device 1 extracts registration biological data whose Hamming distance is a predetermined threshold value or less as a candidate of a search target. Thereafter, the information search device 1 executes a stringent matching process of the searched registration biological data and the biological data input as the query data, and outputs an execution result.

As described above, the information search device 1 narrows down data of a search target by converting a feature quantity vector representing a feature of registration biological data of a search target into a symbol string and calculating a Hamming distance from a symbol string of the query data. Then, the information search device 1 performs matching in biometric authentication by performing matching between the narrowed-down data and the query data.

Here, when the input biological data or registration biological data is an image, for example, a feature quantity vector is obtained by converting density or a numerical value of coordinates of a feature point such as a direction or length of a ridge in a specific region in an image, a gradient, or an end edge or a divergence of a ridge into a vector. Further, when the input biological data or registration biological data is a voice, for example, the feature quantity vector is obtained by converting a numerical value such as the distribution, intensity, or a peak value of a frequency component into a vector.

Here, when registration biological data of a search target is converted into a binary string including “0” or “1,” there are cases in which a distance relation between feature quantity vectors is not reflected. In this regard, the information search device 1 performs conversion into a symbol string including a wild card symbol in which a Hamming distance from a binary symbol is “0” and a binary symbol. Then, the information search device 1 searches for registration biological data in which a Hamming distance between the symbol string including the binary symbol and the wild card symbol and the symbol string converted from the feature quantity vector of the query data is a predetermined threshold value or less as a candidate of a search target, and thus the accuracy of search is improved.

The process executed by the information search device 1 illustrated in FIG. 1 will be concretely described below. The feature quantity vector storage unit 10 stores the feature quantity vector of the registration biological data. Specifically, the feature quantity vector storage unit 10 stores the feature quantity vector of the registration biological data and a data ID used as an identifier of the user who has registered the registration biological data in association with each other.

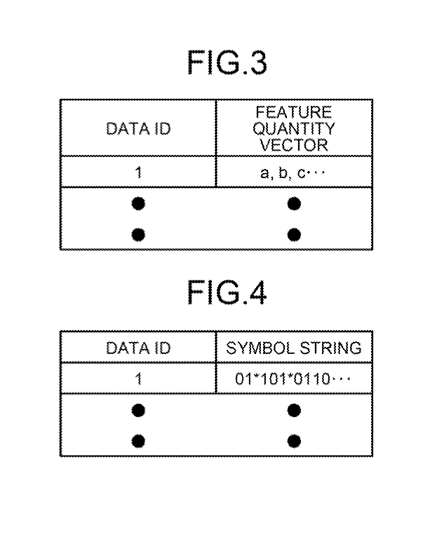

Here, an example of information stored in the feature quantity vector storage unit 10 will be described with reference to FIG. 3. FIG. 3 is a diagram for describing an example of information stored in the feature quantity vector storage unit. For example, in the example illustrated in FIG. 3, the feature quantity vector storage unit 10 stores a data ID “1” in association with “a,” “b,” and “c” as a plurality of feature quantity vectors. Although not illustrated in FIG. 3, the feature quantity vector storage unit 10 stores another feature quantity vector in association with the data ID “1.” Further, the feature quantity vector storage unit 10 stores the feature quantity vector in association with another data ID.

As described above, the feature quantity vector storage unit 10 stores feature quantity vectors of a plurality of pieces of registration biological data for each data ID, that is, for each user who has registered the registration biological data. In the following description, feature quantity vectors associated with the same data ID, that is, feature quantity vectors of the registration biological data registered by the same user are described as feature quantity vectors belonging to the same class.

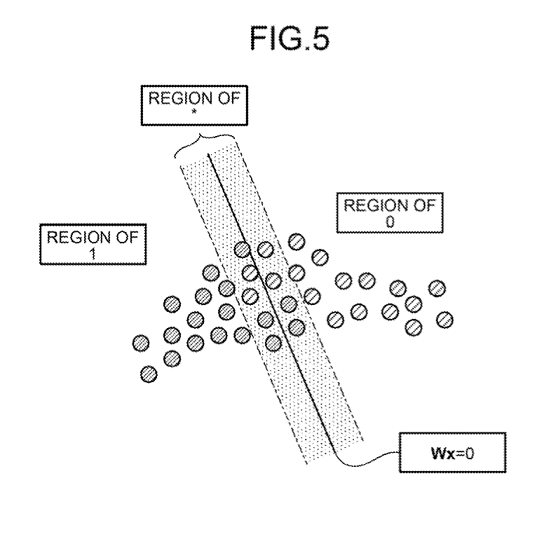

Referring back to FIG. 1, the symbol string data index storage unit 11 stores the symbol string including the binary symbol and the wild card symbol, which is the symbol string converted from the feature quantity vector by a predetermined conversion function in association with the data ID. An example of information stored in the symbol string data index storage unit 11 will be described below with reference to FIG. 4.

FIG. 4 is a diagram for describing an example of information stored in the symbol string data index storage unit. For example, in the example illustrated in FIG. 4, the symbol string data index storage unit 11 stores a symbol string “01*101*0110 . . . ” in association with the data ID “1.” Here, “*” in the symbol string represents a wild card symbol.

Further, although not illustrated in FIG. 4, the symbol string data index storage unit 11 stores a plurality of other symbol strings in association with the data ID “1.” In other words, the symbol string data index storage unit 11 stores a plurality of symbol strings each of which is converted from a feature quantity vector which is stored in the feature quantity vector storage unit 10 in association with the data ID for each data ID.

Referring back to FIG. 1, the conversion function learning unit 12 converts the feature quantity vector stored in the feature quantity vector storage unit 10 into the symbol string including the binary symbol and the wild card symbol, and stores the converted symbol string in the symbol string data index storage unit 11.

Specifically, when a certain component of a feature quantity vector belonging to a certain class falls within a predetermined range from the boundary with a feature quantity vector of a different class, the conversion function learning unit 12 generates a conversion function of converting this component into a wild card symbol. Further, when a certain component of a feature quantity vector belonging to a certain class does not fall within a predetermined range from the boundary with a feature quantity vector of a different class, the conversion function learning unit 12 generates a conversion function of converting this component into a binary symbol corresponding to a value of this component.

In detail, the conversion function learning unit 12 calculates a product of a feature quantity vector and a predetermined conversion matrix, and when a certain component of the calculated product falls within a predetermined range, the conversion function learning unit 12 generates a conversion function of converting the certain component into a wild card symbol. Further, the conversion function learning unit 12 calculates a product of a feature quantity vector and a predetermined conversion matrix, and when a certain component of the calculated product does not fall within a predetermined range, the conversion function learning unit 12 generates a conversion function of converting the certain component into a binary symbol corresponding to a value of the certain component.

Then, the conversion function learning unit 12 converts the feature quantity vector stored in the feature quantity vector storage unit 10 into a symbol string using the generated conversion function, and stores the converted symbol string in the symbol string data index storage unit 11.

In addition, the conversion function learning unit 12 generates a conversion function using a feature quantity vector previously stored in the feature quantity vector storage unit 10. Specifically, the conversion function learning unit 12 extracts two feature quantity vectors stored in the feature quantity vector storage unit 10, regards one feature quantity vector as query data, and regards the other feature quantity vector as a feature quantity vector of data of a search target.

Then, the conversion function learning unit 12 calculates a Euclidean distance (norm) between the extracted two feature quantity vectors. Further, the conversion function learning unit 12 converts the extracted feature quantity vector into a symbol string using a predetermined conversion function, and calculates a Hamming distance in the converted symbol string. Then, the conversion function learning unit 12 evaluates the conversion function that has converted the feature quantity vector based on the calculated Euclidean distance and the Hamming distance. Thereafter, the conversion function learning unit 12 changes a parameter of the conversion function based on the evaluation result of the conversion function.

Further, the conversion function learning unit 12 extracts two feature quantity vectors again, and converts the extracted feature quantity vectors into a symbol string using the conversion function having the changed parameter. Further, the conversion function learning unit 12 evaluates the conversion function based on the Euclidean distance of the re-extracted feature quantity vectors and the Hamming distance in the symbol string, and changes a parameter of the conversion function based on the evaluation result.

Then, by repeating the above-described process twice or more, the conversion function learning unit 12 optimizes the parameter of the conversion function. Thereafter, the conversion function learning unit 12 converts the feature quantity vector stored in the feature quantity vector storage unit 10 into a symbol string using the conversion function having the optimized parameter, and stores the converted symbol string in the symbol string data index storage unit 11.

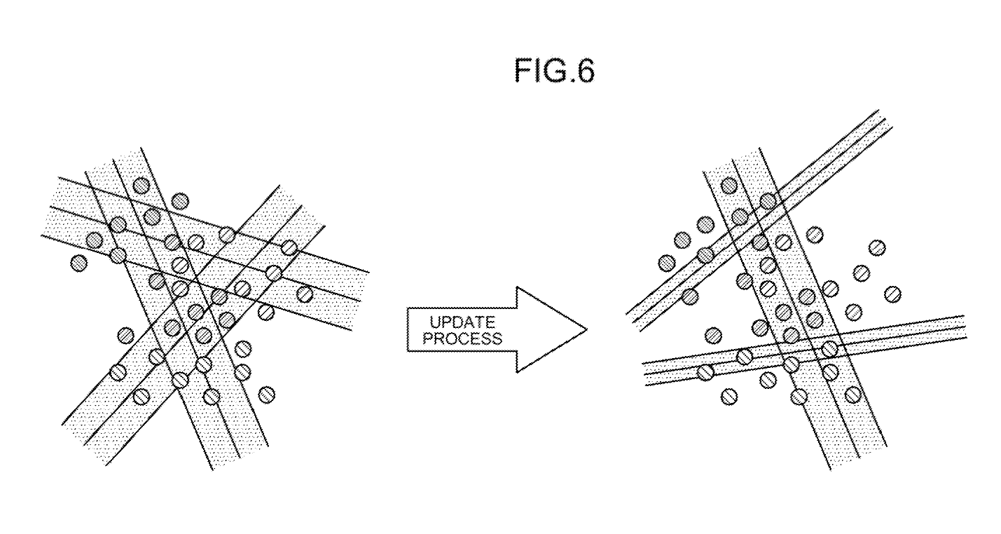

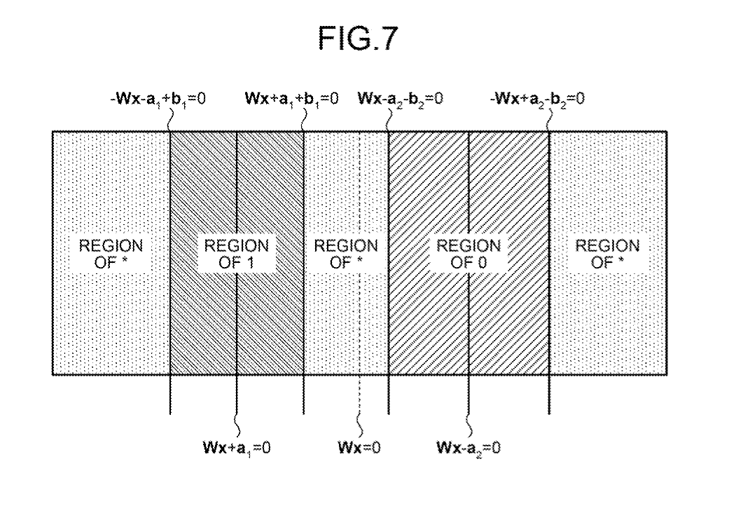

Next, the conversion function generated by the conversion function learning unit 12 will be described with reference to FIGS. 5 and 6. First, a component of a feature quantity vector which is converted into a wild card symbol by the conversion function will be described with reference to FIG. 5.

FIG. 5 is a diagram for describing a component which is converted into a wild card symbol by the conversion function. FIG. 5 illustrates an example in which a two-dimensional feature quantity vector is converted into a symbol string. Further, in the example illustrated in FIG. 5, feature quantity vectors respectively belonging to different classes are indicated by different hatched lines. Further, in FIG. 5, a boundary line in which a product of a conversion matrix W and a feature quantity vector x is “0” is indicated by a straight line.

For example, in the method according to the related art, a feature quantity vector included in a range at the right of the straight line in FIG. 5 is converted into a symbol string of “0,” and a feature quantity vector included in a range at the left of the straight line in FIG. 5 is converted into a symbol string of “1.” However, when a stereotypical conversion using a threshold value is performed, a feature quantity vector present at the boundary with a feature quantity vector of a different class, that is, a feature quantity vector present near the boundary line is converted into a symbol string different from a feature quantity vector of the same class. As a result, in the method according to the related art, search omission of a feature quantity vector present in the boundary with a feature quantity vector of a different class occurs.

In this regard, the information search device 1 converts a feature quantity vector included in a predetermined range from the boundary in which the product of the conversion matrix W and the feature quantity vector x is “0” into a wild card symbol “*.” Here, the distance between the wild card symbol “*” and the boundary symbol “1” or “0” is determined to be “0” in a calculation of the Hamming distance. For this reason, the information search device 1 causes a feature quantity vector present near the boundary line in which the product of the conversion matrix W and the feature quantity vector x is “0” to be included in the search result, and thus can prevent search omission.

For example, a feature quantity vector indicated by thin hatching in FIG. 5 is classified into as a feature quantity vector of a class A, and a feature quantity vector indicated by thick hatching in FIG. 5 is classified into as a feature quantity vector of a class B. In this case, most of the feature quantity vectors of the class A are converted into the symbol string “0,” and a feature quantity vector present near the boundary with the feature quantity vector of the class B is converted into the wild card symbol “*.” Thus, when a symbol string converted from query data is “0,” the information search device 1 can cause not only the feature quantity vector converted into the symbol string “0” but also the feature quantity vector converted into the symbol string “*” to be included in the search result. As a result, the information search device 1 can prevent search omission of the feature quantity vector belonging to the class A.

Next, a process by which the conversion function learning unit 12 optimizes the conversion function by repeatedly evaluating the conversion function and changing the parameter will be described with reference to FIG. 6.

FIG. 6 is a diagram for describing a process of updating the conversion function such that a distance relation between symbol strings is maintained. In an example illustrated in FIG. 6, two-dimensional feature quantity vectors belonging to different classes are indicated by different hatched lines, similarly to FIG. 5. Further, in an example illustrated in FIG. 6, a two-dimensional feature quantity vector is converted into a three-digit symbol string using three threshold values.

As illustrated in FIG. 6, a conversion function of an initial state is difficult to successfully divide a feature quantity vector of each class by a boundary line used to convert a feature quantity vector belonging to each class into a symbol string. In this regard, the conversion function learning unit 12 extracts arbitrary two feature quantity vectors, and evaluates the conversion function based on an Euclidean distance of the extracted feature quantity vectors and a Hamming distance of a symbol string converted from the feature quantity vectors.

Specifically, the conversion function learning unit 12 updates the conversion function such that the Hamming distance in the converted symbol string is decreased when the Euclidean distance between the feature quantity vectors is short, but the Hamming distance in the converted symbol string is increased when the Euclidean distance between the feature quantity vectors is long. Further, when the extracted feature quantity vectors belong to the same class, the Euclidean distance between the feature quantity vectors is decreased. Thus, when the Euclidean distance between the feature quantity vectors is short and so the Hamming distance in the symbol string is decreased, the conversion function learning unit 12 can decrease the Hamming distance in the symbol string converted from the feature quantity vector belonging to the same class.

As a result, the conversion function learning unit 12 updates the conversion function such that the feature quantity vector belonging to each class is successfully divided by the boundary line as illustrated at the right side of FIG. 6. In addition, the conversion function learning unit 12 updates a range used for conversion into the wild card symbol “*” when updating the conversion function. As a result, the conversion function learning unit 12 can prevent search omission when converting the feature quantity vector into the symbol string and calculating the Hamming distance with the symbol string converted from the query data.

In addition, the conversion function learning unit 12 updates the conversion function using the feature quantity vector stored in the feature quantity vector storage unit 10. Thus, the conversion function learning unit 12 can obtains the conversion function optimized for data of a search target. Furthermore, the conversion function learning unit 12 may optimize the conversion function in view of the class to which the extracted feature quantity vector belongs as well as the Euclidean distance between the extracted feature quantity vectors or the Hamming distance of the symbol string converted from the extracted feature quantity vector.

Next, a concrete example by which the conversion function learning unit 12 updates a predetermined conversion function and generates an optimized conversion function will be described. In the following description, the conversion function generated by the conversion function learning unit 12 will be first described, and then a process of changing parameters of the conversion function based on the evaluation result of the conversion function and optimizing the conversion function will be described.

First, the description will proceed with the conversion function generated by the conversion function learning unit 12. For example, when the conversion function learning unit 12 converts the feature quantity vector into the symbol string having the binary symbol and the wild card symbol, a converted symbol string c is represented by the following Formula (1). In Formula (1), p represents the number of symbols (a dimension number) of the symbol string.

cεC≡{0,1,*}^{p} (1)

Next, a Hamming distance mᵢⱼ between a symbol string cᵢ and a symbol string cⱼ is defined as in the following Formula (2). Here, in Formula (2), s(c^{k}ᵢ, c^{k}ⱼ) is a value represented by the following Formula (3), and c^{k} is a k-th symbol in a symbol string c.

$$\begin{matrix}{m}_{ij} = {\sum }_{k = 1}^{p} s ( {c}_{i}^{k} , {c}_{j}^{k} ) & ( 2 ) \\ s ( {c}_{i}^{k} , {c}_{j}^{k} ) = \{ \begin{matrix}1 & if ( {c}_{i}^{k} = 0 ⋀ {c}_{j}^{k} = 1 ) ⋁ ( {c}_{i}^{k} = 1 ⋀ {c}_{j}^{k} = 0 ) \\ 0 & otherwise\end{matrix} & ( 3 )\end{matrix}$$

Here, various variations can be made on the conversion function, but, for example, the conversion function learning unit 12 sets the conversion function represented by the following Formula (4). Here, u^{k} is a k-th value in a symbol string u.

$${c}^{k} = \{ \begin{matrix}1 & if {u}^{k} = 1 \\ 0 & if {u}^{k} = - 1 \\ * & if {u}^{k} = 0\end{matrix} \qquad ( 4 )$$

Further, the symbol string u is a symbol string defined by the following Formula (5). In Formula (5), a bold-faced x is an n-dimensional feature quantity vector, and a bold-faced W is an n×p conversion matrix of. In Formula (5), bold-faced a₁, a₂, b₁, and b₂ are p-dimensional vectors. Further, a₁, a₂, b₁, and b₂ are parameters of the conversion function used to decide a range used for conversion into a wild card symbol, and each element is assumed to have a value of zero (0) or more. Furthermore, bold-faced h⁺ and h⁻ are p-dimensional vectors in which each element is “0” or “1,” and bold-faced g⁺ and g⁻ are p-dimensional vectors in which each element is “0” or “−1.”

$$u = {argmax}_{{h}^{+} ∈ {[ 0 , 1 ]}^{p}} [ {h}^{+} ( Wx + {a}_{1} + {b}_{1} ) ] + {argmax}_{{h}^{-} ∈ {[ 0 , 1 ]}^{p}} [ {h}^{-} ( - Wx - {a}_{1} + {b}_{1} ) ] + {argmax}_{{g}^{+} ∈ {[ 0 , - 1 ]}^{p}} [ {g}^{+} ( Wx - {a}_{2} - {b}_{2} ) ] + {argmax}_{{g}^{-} ∈ {[ 0 , - 1 ]}^{p}} [ {g}^{-} ( - Wx + {a}_{2} - {b}_{2} ) ] \qquad ( 5 )$$

In other words, the conversion function learning unit 12 obtains h⁺, h⁻, g⁺, and g⁻ that cause a value in which each parameter is considered on the product of the conversion matrix and the feature quantity vector to be maximum in each term in Formula (5), and calculates a vector u using the calculated h⁺, h⁻, g⁺, and g⁻.

Here, FIG. 7 is a diagram for describing an example of the conversion function. FIG. 7 illustrates an example in which the symbol string u expressed by Formula (5) is converted into the conversion function expressed by Formula (4), a two-dimensional feature quantity vector is converted into any one of “0,” “1,” and “*.” In detail, illustrated is a range in which conversion into a binary symbol which is decided based on the product of the feature quantity vector and the conversion matrix in FIG. 5 and a wild card symbol which is decided based on the parameters a₁, a₂, b₁, and b₂ in FIG. 5 is performed.

For example, as illustrated in FIG. 7, a feature quantity vector included in a range satisfying Wx+a₁+b₁=0 from a range satisfying −Wx−a₁+b₁=0 is converted into a boundary symbol “1.” A feature quantity vector included in a range satisfying Wx−a₂−b₂=0 from a range satisfying Wx+a₁+b₁=0 is converted into a wild card symbol “*.” In other words, a feature quantity vector included in a predetermined range from the boundary in which the product Wx of the feature quantity vector and the conversion matrix is zero (0) is converted into the wild card symbol “*.”

Further, a feature quantity vector included in a range satisfying −Wx+a₂-b₂=0 from a range satisfying Wx−a₂−b₂=0 is converted into a binary symbol “0.” Further, a feature quantity vector included in a range in which −Wx−a₁+b₁ is zero (0) or more or a range in which −Wx+a₂−b₂ is zero (0) or more is converted into the wild card symbol “*.”

Next, the description will proceed with a process by which the conversion function learning unit 12 changes the parameters a₁, a₂, b₁, and b₂ of the conversion function based on the evaluation result of the conversion function and optimizes the conversion function. For example, a conversion function that converts a feature quantity vector into a symbol string while maintaining a distance relation in an original feature quantity vector space as much as possible is preferably used as the conversion function used by the information search device 1.

In this regard, for example, the conversion function learning unit 12 can evaluate the conversion function using an evaluation function expressed by the following Formula (6). Here, in Formula (6), dᵢⱼ is an Euclidean distance between a feature quantity vector i and a feature quantity vector j. Further, in Formula (6), S is a data set of the feature quantity vector stored in the feature quantity vector storage unit 10.

$${\sum }_{( i , j ) ∈ S} {l}_{1} ( {m}_{ij} , {d}_{ij} ) = {\sum }_{( i , j ) ∈ S} {( \frac{1}{p} {m}_{ij} - \frac{1}{2} {d}_{ij} )}^{2} \qquad ( 6 )$$

In other words, the conversion function learning unit 12 evaluates the conversion function as being high when it is determined that similarity between a relation of a Euclidean distance in a feature quantity space and a relation of a distance between symbol strings is high using Formula (6). As another example, the conversion function learning unit 12 evaluates the conversion function using the following Formula (7). Here, in Formula (7), l₂(mᵢⱼ,tᵢⱼ) is a value expressed in by the following Formula (8). Further, in Formulas (7) and (8), t is “1” when the feature quantity vector i and the feature quantity vector j belong to the same class but is zero (0) when the feature quantity vector i and the feature quantity vector j belong to different classes.

$$\begin{matrix}{\sum }_{( i , j ) ∈ S} {l}_{2} ( {m}_{ij} , {t}_{ij} ) & ( 7 ) \\ {l}_{2} ( {m}_{ij} , {t}_{ij} ) = \{ \begin{matrix}max ( {m}_{ij} - ρ + 1 , 0 ) & if {t}_{ij} = 1 \\ max ( ρ - {m}_{ij} + 1 , 0 ) & if {t}_{ij} = 0\end{matrix} & ( 8 )\end{matrix}$$

In other words, the conversion function learning unit 12 causes the Hamming distance between the symbol strings to be smaller than “ρ” on feature quantity vectors of the same class and causes the Hamming distance between the symbol strings to be “ρ” or more on feature quantity vectors of different classes using Formulas (7) and (8). The following description will proceed with an example in which the conversion function learning unit 12 evaluates the conversion function using Formulas (7) and (8).

Here, Formulas (7) and (8) have a low value on the conversion function that causes the Hamming distance between the symbol strings to be smaller than “ρ” on feature quantity vectors of the same class and causes the Hamming distance between the symbol strings to be “ρ” or more on feature quantity vectors of different classes. For this reason, the conversion function learning unit 12 preferably optimizes the conversion matrix W and the parameter a₁, a₂, b₁, b₂ of the conversion function such that a value of Formula (7) serving as the evaluation function is reduced.

Here, Formula (7) serving as the evaluation function is a discontinuous function. For this reason, let us consider a case of minimizing an upper limit of Formula (7). For example, the conversion function learning unit 12 regards the feature quantity vector i as registration data and the feature quantity vector j as query data. Here, a conversion formula used to convert query data into a binary string is defined by the following Formula (9). In Formula (9), x_{q} is a feature quantity vector serving as query data.

$${b}_{q} = {argmax}_{h ∈ {[ 0 , 1 ]}^{p}} [ {hWx}_{q} ] \qquad ( 9 )$$

In this case, the upper limit of Formula (7) serving as the evaluation function can be expressed by the following Formula (10).

$${\sum }_{( i , j ) ∈ S} {l}_{2} ( {m}_{ij} , {t}_{ij} ) \leq {\sum }_{( i , j ) ∈ S} \{ {max}_{{h}_{i}^{+} , {h}_{i}^{-} , {h}_{j} ∈ {[ 0 , 1 ]}^{p} , {g}_{i}^{+} , {g}_{i}^{-} ∈ {[ 0 , - 1 ]}^{p}} [ {l}_{2} ( {m}_{ij} , {t}_{ij} ) + {h}_{i}^{+} ( {Wx}_{i} + {a}_{1} + {b}_{1} ) + {h}_{i}^{-} ( - {Wx}_{i} - {a}_{1} + {b}_{1} ) + {g}_{i}^{+} ( {Wx}_{i} - {a}_{2} - {b}_{2} ) + {g}_{i}^{-} ( - {Wx}_{i} + {a}_{2} - {b}_{2} ) + {h}_{j} {Wx}_{j} ] - {max}_{{h}_{i}^{+} ∈ {[ 0 , 1 ]}^{p}} [ {h}_{i}^{+} ( {Wx}_{i} + {a}_{1} + {b}_{1} ) ] - {max}_{{h}_{i}^{-} ∈ {[ 0 , 1 ]}^{p}} [ {h}_{i}^{-} ( - {Wx}_{i} - {a}_{1} + {b}_{1} ) ] - {max}_{{g}_{i}^{+} ∈ {[ 0 , - 1 ]}^{p}} [ {g}_{i}^{+} ( {Wx}_{i} - {a}_{2} - {b}_{2} ) ] - {max}_{{g}_{i}^{-} ∈ {[ 0 , - 1 ]}^{p}} [ {g}_{i}^{-} ( - {Wx}_{i} + {a}_{2} - {b}_{2} ) ] - {max}_{{h}_{j} ∈ {[ 0 , 1 ]}^{p}} [ {h}_{j} {Wx}_{j} ] \} \qquad ( 10 )$$

Referring to a first term of Formula (10), l₂(mᵢⱼ,tᵢⱼ) is a value unrelated to hᵢ⁺, hᵢ⁻, hⱼ, gᵢ⁺, and gᵢ⁻ thus can be expressed as in the following Formula (11).

$${l}_{2} ( {m}_{ij} , {t}_{ij} ) + {max}_{{h}_{i}^{+} , {h}_{i}^{-} , {h}_{j} ∈ {[ 0 , 1 ]}^{p} , {g}_{i}^{+} , {g}_{i}^{-} ∈ {[ 0 , - 1 ]}^{p}} [ \begin{matrix}{h}_{i}^{+} ( {Wx}_{i} + {a}_{1} + {b}_{1} ) + \\ {h}_{i}^{-} ( - {Wx}_{i} - {a}_{1} + {b}_{1} ) + \\ {g}_{i}^{+} ( {Wx}_{i} - {a}_{2} - {b}_{2} ) + \\ {g}_{i}^{-} ( - {Wx}_{i} + {a}_{2} - {b}_{2} ) + {h}_{j} {Wx}_{j}\end{matrix} ] \qquad ( 11 )$$

Here, when each of hᵢ⁺, hᵢ⁻, hⱼ, gᵢ⁺, and gᵢ⁻ that satisfy a calculation expressed by Formula (11) is represented by a symbol with a wavy line thereabove, the right side of Formula (10) can be expressed by the following Formula (12):

$${\sum }_{( i , j ) ∈ S} \{ {l}_{2} ( {m}_{ij} , {t}_{ij} ) + {\tilde{h}}_{i}^{+} ( {Wx}_{i} + {a}_{1} + {b}_{1} ) + {\tilde{h}}_{i}^{-} ( - {Wx}_{i} - {a}_{1} + {b}_{1} ) + {\tilde{g}}_{i}^{+} ( {Wx}_{i} - {a}_{2} - {b}_{2} ) + {\tilde{g}}_{i}^{-} ( - {Wx}_{i} + {a}_{2} - {b}_{2} ) + {\tilde{h}}_{j} {Wx}_{j} - {h}_{i}^{′ +} ( {Wx}_{i} + {a}_{1} + {b}_{1} ) - {h}_{i}^{′ -} ( - {Wx}_{i} - {a}_{1} + {b}_{1} ) - {g}_{i}^{′ +} ( {Wx}_{i} - {a}_{2} - {b}_{2} ) - {g}_{i}^{′ -} ( - {Wx}_{i} + {a}_{2} - {b}_{2} ) - {h}_{j}^{′} {Wx}_{j} \} \qquad ( 12 )$$

Here, for a maximum calculation of hᵢ⁺, hᵢ⁻, hⱼ, gᵢ⁺, and gᵢ⁻, conversion expressed by the following Formula (13) to (17) has been performed.

$$\begin{matrix}{max}_{{h}_{i}^{+} ∈ {[ 0 , 1 ]}^{p}} [ {h}_{i}^{+} ( {Wx}_{i} + {a}_{1} + {b}_{1} ) ] = {h}_{i}^{′ +} ( {Wx}_{i} + {a}_{1} + {b}_{1} ) & ( 13 ) \\ {max}_{{h}_{i}^{-} ∈ {[ 0 , 1 ]}^{p}} [ {h}_{i}^{-} ( - {Wx}_{i} - {a}_{1} + {b}_{1} ) ] = {h}_{i}^{′ -} ( - {Wx}_{i} - {a}_{1} + {b}_{1} ) & ( 14 ) \\ {max}_{{g}_{i}^{+} ∈ {[ 0 , - 1 ]}^{p}} [ {g}_{i}^{+} ( {Wx}_{i} - {a}_{2} - {b}_{2} ) ] = {g}_{i}^{′ +} ( {Wx}_{i} - {a}_{2} - {b}_{2} ) & ( 15 ) \\ {max}_{{g}_{i}^{-} ∈ {[ 0 , - 1 ]}^{p}} [ {g}_{i}^{-} ( - {Wx}_{i} + {a}_{2} - {b}_{2} ) ] = {g}_{i}^{′ -} ( - {Wx}_{i} + {a}_{2} - {b}_{2} ) & ( 16 ) \\ {max}_{{h}_{j} ∈ {[ 0 , 1 ]}^{p}} [ {h}_{j} {Wx}_{j} ] = {h}_{j}^{′} {Wx}_{j} & ( 17 )\end{matrix}$$

Next, the conversion function learning unit 12 optimizes the conversion matrix of Formula (12) and the parameters using a stochastic gradient descent (SGD) technique. Specifically, the conversion function learning unit 12 sequentially updates the conversion matrix W and the parameters a₁, a₂, b₁, and b₂ of the conversion function using the following Formulas (18) to Formula (22), and minimizes the upper limit of Formula (7). In Formulas (18) to (22), η is a parameter representing a learning rate.

w^{t+1}=w^{t}−η{\tilde{h}ᵢ⁺xᵢ^{T}−\tilde{h}ᵢ⁻xᵢ^{T}+\tilde{g}ᵢ⁺xᵢ^{T}+\tilde{g}ᵢ⁻xᵢ^{T}+\tilde{h}ⱼxⱼ^{T}−hᵢ′⁺xᵢ^{T}+hᵢ′⁻xᵢ^{T}−gᵢ′⁺xᵢ^{T}+gᵢ′⁻xᵢ^{T}−hⱼ′xⱼ^{T}} (18)

a₁^{t+1}=a₁^{t}−η{\tilde{h}ᵢ⁺−\tilde{h}ᵢ⁻−hᵢ′⁺+hᵢ′⁻} (19)

a₂^{t+1}=a₁^{t}−η{−\tilde{g}ᵢ⁺+\tilde{g}ᵢ⁻+gᵢ′⁺−gᵢ′⁻} (20)

b₁^{t+1}=b₁^{t}−η{\tilde{h}ᵢ⁺+\tilde{h}ᵢ⁻−hᵢ′⁺−hᵢ′⁻} (21)

b₂^{t+1}=b₂^{t}−η{−\tilde{g}ᵢ⁺−\tilde{g}ᵢ⁻+gᵢ′⁺+gᵢ′⁻} (22)

As described above, the conversion function learning unit 12 extracts a feature quantity vector from the feature quantity vector storage unit 10, and repeats a process of calculating Formulas (18) to (22) by a predetermined number of times. Then, the conversion function learning unit 12 calculates the conversion matrix and the parameter to minimize the upper limit of Formula (7) by sequentially updating the conversion matrix W and the parameters a₁, a₂, b₁, and b₂ of the conversion function. In other words, the conversion function learning unit 12 optimizes the conversion matrix W and the parameters a₁, a₂, b₁, and b₂ of the conversion function.

Thereafter, the conversion function learning unit 12 converts the feature quantity vector stored in the feature quantity vector storage unit 10 into a symbol string using the optimized conversion matrix W and the parameters a₁, a₂, b₁, and b₂ of the conversion function, and stores the converted symbol string in the symbol string data index storage unit 11. Further, the conversion function learning unit 12 notifies the feature quantity converting unit 13 of the optimized conversion matrix W.

The above description has been made in connection with an example in which the conversion matrix W and the parameters a₁, a₂, b₁, and b₂ of the conversion function are optimized using the stochastic gradient descent technique, but the conversion function learning unit 12 may minimize the upper limit of Formula (7) using another optimization algorithm.

In addition, the conversion function learning unit 12 optimizes the conversion matrix W and the parameters a₁, a₂, b₁, and b₂ of the conversion function by repeating the above-described process by a predetermined number of times. However, the conversion function learning unit 12 may determine that the conversion matrix W and the parameters a₁, a₂, b₁, and b₂ of the conversion function have been optimized when a predetermined condition is satisfied. For example, the conversion function learning unit 12 may determine that the conversion matrix W and the parameters a₁, a₂, b₁, and b₂ of the conversion function have been optimized when the value of the evaluation function expressed by Formula (7) is a predetermined threshold value or less.

Referring back to FIG. 1, when query data is received from the client device 2, the feature quantity converting unit 13 generates a feature quantity vector from the received query data. Further, the feature quantity converting unit 13 converts query data into a binary string b_{q} using the conversion matrix W received from the conversion function learning unit 12 and Formula (9). Then, the feature quantity converting unit 13 transmits the feature quantity vector and the binary string b_{q} to the search unit 14.

Here, when the feature quantity vector and the binary string b_{q} are received from the feature quantity converting unit 13, the search unit 14 executes the following process. First, the search unit 14 calculates the Hamming distance between the received binary string b_{q} and each symbol string stored in the symbol string data index storage unit 11. For example, when the received binary string b_{q} is “110100” and the symbol string is “110110,” the search unit 14 calculates “1” as the Hamming distance. Further, since the Hamming distance between the wild card symbol and the binary symbol is “0,” when the received binary string b_{q} is “110100” and the symbol string is “1001*0,” the search unit 14 calculates “1” as the Hamming distance.

Then, the search unit 14 extracts a symbol string whose Hamming distance is a predetermined value or less, that is, a symbol string of a feature quantity vector which is a neighbor candidate of query data. Further, the search unit 14 acquires a feature quantity vector which is a source of the extracted symbol string from the feature quantity vector storage unit 10, and compares the extracted feature quantity vector with the feature quantity vector acquired from the feature quantity vector storage unit 10.

Thereafter, when a feature quantity vector matching with the feature quantity vector acquired from the feature quantity converting unit 13 or a feature quantity vector whose Euclidean distance is a predetermined threshold value or less is present among the feature quantity vectors acquired from the feature quantity vector storage unit 10, the search unit 14 executes the following process. In other words, the search unit 14 notifies the client device 2 of the fact that the query data matches with the registration biological data.

However, when a feature quantity vector matching with the feature quantity vector acquired from the feature quantity converting unit 13 or a feature quantity vector whose Euclidean distance is a predetermined threshold value or less is not present among the feature quantity vectors acquired from the feature quantity vector storage unit 10, the search unit 14 executes the following process. In other words, the search unit 14 notifies the client device 2 of the fact that the query data does not match with the registration biological data. As a result, the client device 2 can perform biometric authentication of the user who has inputted the query data.

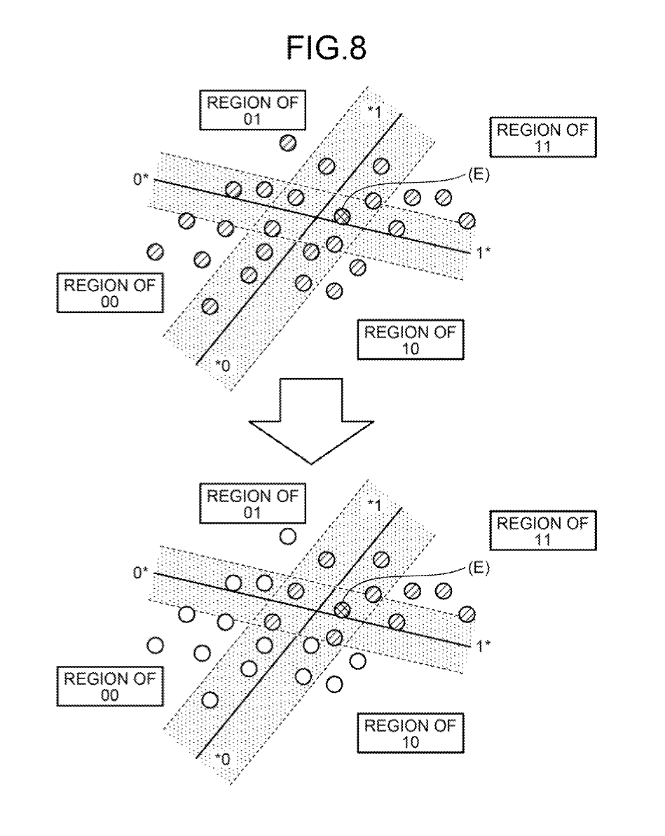

Here, a process by which the search unit 14 extracts a symbol string of a feature quantity vector serving as a neighbor candidate of query data will be described with reference to FIG. 8. FIG. 8 is a diagram for describing a process of extracting a symbol string of a feature quantity vector serving as a neighbor candidate of query data. In an example illustrated in FIG. 8, the information search device 1 converts a feature quantity vector into a symbol string of any one of “11,” “10,” “00,” and “01,” and a feature quantity vector positioned in a shaded portion in FIG. 8 into a symbol string including a wild card symbol.

In other words, the information search device 1 converts a feature quantity vector which is present within a predetermined range from the boundary of a threshold value used for conversion into a symbol string into a symbol string including a wild card symbol. For example, when a feature quantity vector indicated by (E) in FIG. 8 is received from the feature quantity converting unit 13, the search unit 14 extracts a feature quantity vector in which a symbol string is converted into “11.” Further, since the Hamming distance between the wild card symbol and the binary symbol is “0,” the search unit 14 extracts a feature quantity vector included in a shaded range in FIG. 8.

As a result, the search unit 14 excludes feature quantity vectors indicated by white circles in a lower portion of FIG. 8 from the neighbor candidate of the query data, and includes feature quantity vectors indicated by hatched circles in the lower portion of FIG. 8 as the neighbor candidate of the query data. As a result, the information search device 1 can prevent search omission.

In addition, the search unit 14 extracts a feature quantity vector serving as the neighbor candidate of the query data by calculating the Hamming distance between the binary string converted from the query data and the symbol string converted from the feature quantity vector. Then, the search unit 14 calculates a Euclidean distance between the extracted feature quantity vector and the feature quantity vector of the query data. As a result, the search unit 14 can reduce a search cost for executing the search process.

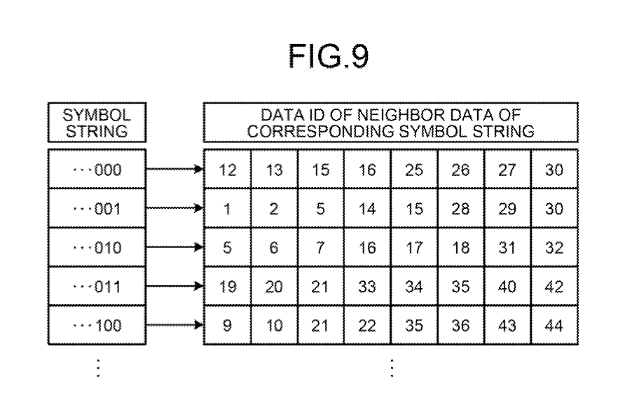

In addition, the search unit 14 may further increase the speed of the search process using a hash table. In this regard, an example in which the search unit 14 performs a search process using a hash table will be described with reference to FIG. 9.

FIG. 9 is a diagram for describing an example of a hash table stored in a search unit. For example, in an example illustrated in FIG. 9, the search unit 14 stores a data ID of a feature quantity vector present near a feature quantity vector which is a source of an associated symbol string in association with each symbol string. For example, the search unit 14 acquires a symbol string c stored in the symbol string data index storage unit 11. Further, the search unit 14 generates binary strings of 2^{r} types obtained by converting r wild card symbols “*” included in the symbol string c into the boundary symbol “1” or “0.”

Further, the search unit 14 generates a hash table associated with a data ID of a feature quantity vector present near a feature quantity vector which is a conversion source of a source symbol string on the generated binary string. Then, when the binary string converted from the feature quantity vector of the query data is received, the search unit 14 acquires a data ID associated with the received binary string from the hash table. Thereafter, the search unit 14 acquires a feature quantity vector associated with the data ID acquired from the hash table from the feature quantity vector storage unit 10, and calculates the Euclidean distance from the feature quantity vector of the query data.

As described above, the search unit 14 stores the hash table in which the symbol string is associated with the data ID of the feature quantity vector present near the feature quantity vector which is the source of the symbol string. As a result, the search unit 14 can execute the search process at a high speed.

For example, the conversion function learning unit 12, the feature quantity converting unit 13, and the search unit 14 include an electronic circuit. Here, an integrated circuit (IC) such as an application specific integrated circuit (ASIC) or a field programmable gate array (FPGA), a central processing unit (CPU), or a micro processing unit (MPU) is applied as the electronic circuit.

Further, the feature quantity vector storage unit 10 and the symbol string data index storage unit 11 are memory devices such as a semiconductor memory device such as a random access memory (RAM) or a flash memory, a hard disk, or an optical disk.

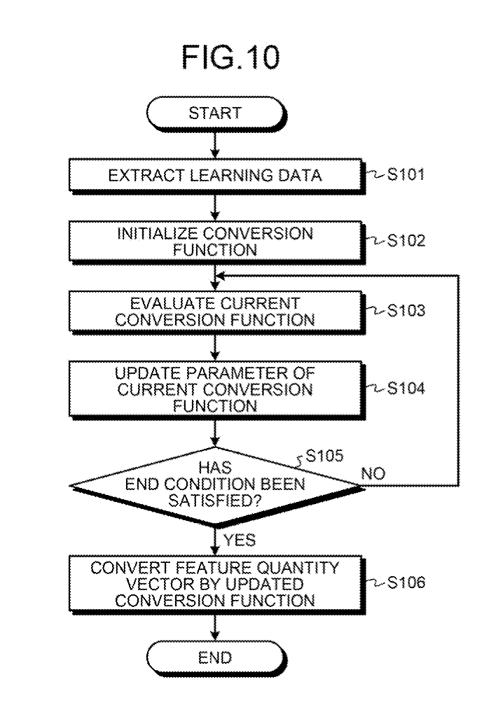

Next, the flow of a process by which the information search device 1 generates the conversion function will be described with reference to FIG. 10. FIG. 10 is a flowchart for describing the flow of a process of generating the conversion function. The information search device 1 starts the process when a new feature quantity vector is registered in the feature quantity vector storage unit 10 from an external device which is not illustrated in FIG. 1.

First, the information search device 1 extracts arbitrary two feature quantity vectors from the feature quantity vector storage unit 10 as learning data (step S101). Next, the information search device 1 initializes the conversion function (step S102). In other words, the information search device 1 sets the conversion matrix W of the conversion function and the values of the parameters a₁, a₂, b₁, and b₂ of the conversion function to predetermined initial values. Then, the information search device 1 evaluates the current conversion function (step S103). In other words, the information search device 1 converts the extracted learning data into a symbol string using the current conversion function, and evaluates the current conversion function using the Hamming distance between the converted symbol strings and the Euclidean distance of the learning data.

Then, the information search device 1 updates the conversion matrix W of the current conversion function and the values of the parameters a₁, a₂, b₁, and b₂ of the conversion function using the evaluation result in step S103 (step S104). Next, the information search device 1 determines whether or not an end condition has been satisfied (step S105). For example, the information search device 1 determines whether or not the process of steps S103 to 5104 has been executed by a predetermined number of times or whether or not the evaluation value represented by Formula (7) is a predetermined threshold value or less.

Here, when it is determined that the end condition has been satisfied (Yes in step S105), the information search device 1 converts the feature quantity vector using the updated conversion function (step S106), and ends the process. However, when it is determined that the end condition has not been satisfied (No in step S105), the information search device 1 executes the process of step S103.

Effects of First Embodiment

As described above, the information search device 1 converts a feature quantity vector of data which is a target of the search process using the Hamming distance into a symbol string including a wild card symbol and a binary symbol. Thus, the information search device 1 includes a feature quantity vector present near a threshold value used for conversion into a symbol string as a search candidate and thus prevents search omission.

Further, when a certain component of a feature quantity vector falls within a predetermined range from the boundary with a feature quantity vector of a different class, the information search device 1 converts this component into the wild card symbol “*.” Further, when a certain component of a feature quantity vector does not fall within a predetermined range from the boundary with a feature quantity vector of a different class, the information search device 1 converts this component into a binary symbol. Thus, the information search device 1 can convert a feature quantity vector into a symbol string such that search omission does not occur.

In addition, when a certain component of a product of a conversion matrix and a feature quantity vector falls within a predetermined range, the information search device 1 converts this component into the wild card symbol “*,” but when the certain component does not fall within a predetermined range, the information search device 1 converts this component into a binary symbol corresponding to a value of this component. Thus, when a conversion matrix according to the distribution of feature quantity vectors is selected, the information search device 1 converts a feature quantity vector into a symbol string in a state in which a positional relation of feature quantity vectors is maintained while preventing search omission.

Further, the information search device 1 extracts two feature quantity vectors from the feature quantity vector storage unit 10, and evaluates a predetermined conversion function based on the Euclidean distance between the extracted feature quantity vectors and the Hamming distance between the symbol strings converted from the feature quantity vectors by the predetermined conversion function. Then, the information search device 1 updates the conversion matrix W of the predetermined conversion function and the values of the parameters a₁, a₂, b₁, and b₂ of the conversion function based on the evaluation result. Thus, the information search device 1 converts the feature quantity vector into the symbol string using the optimized conversion function for each distribution of the feature quantity vectors stored in the feature quantity vector storage unit 10.

In addition, the information search device 1 decreases the evaluation value of the conversion function when the feature quantity vectors extracted from the feature quantity vector storage unit 10 are feature quantity vectors of the same class and the Hamming distance between the converted symbol strings is a predetermined value or less at the time of evaluation of the conversion function. Further, the information search device 1 decreases the evaluation value of the conversion function when the feature quantity vectors extracted from the feature quantity vector storage unit 10 are feature quantity vectors of different classes and the Hamming distance between the converted symbol strings is a predetermined value or more at the time of evaluation of the conversion function.

In other words, when feature quantity vectors registered by the same user are converted into a symbol string, the information search device 1 decreases the evaluation value of the conversion function when the Hamming distance is a predetermined value or less. Further, when feature quantity vectors registered by different user are converted into a symbol string, the information search device 1 decreases the evaluation value of the conversion function when the Hamming distance is a predetermined value or more. Then, the information search device 1 updates the conversion matrix W of the predetermined conversion function and the values of the parameter a₁, a₂, b₁, and b₂ of the conversion function such that the upper limit of the evaluation value is decreased. Thus, the information search device 1 can automatically generate the optimal conversion function according to the distribution of the feature quantity vectors stored in the feature quantity vector storage unit 10.

In addition, the information search device 1 stores the feature quantity vector in association with the converted symbol string. Specifically, the information search device 1 stores the feature quantity vector and the converted symbol string in the feature quantity vector storage unit 10 and the symbol string data index storage unit 11 in association with the same data ID. Then, the information search device 1 searches for a feature quantity vector associated with a symbol string that causes the Hamming distance from the binary string converted from the query data to be a predetermined value or less. Thus, the information search device 1 can reduce the computation cost for searching a feature quantity vector positioned near query data.

### [b] Second Embodiment

The embodiment of the present invention has been described so far, but embodiment of various forms can be made in addition to the above-described embodiment. In this regard, another embodiment of the present invention will be described below as a second embodiment.

(1) Regarding Formulas

The above-described information search device 1 performs conversion of the feature quantity vector, conversion of the query data, evaluation of the conversion function, and optimization of the conversion matrix W and the parameters a₁, a₂, b₁, and b₂ of the conversion function using Formulas (1) to (22). However, the embodiment is not limited to this example.

In other words, the information search device 1 may appropriately employ a conversion function of performing conversion into a symbol string including a wild card symbol at the time of conversion of a feature quantity vector. Further, the information search device 1 does not need to convert a feature quantity vector of query data using an optimized conversion matrix W and may convert a feature quantity vector of query data into a binary string using an arbitrary conversion matrix.

Further, the information search device 1 decreases the upper limit of the evaluation function using the stochastic gradient descent technique and optimizes the conversion matrix W and the parameter a₁, a₂, b₁, and b₂ of the conversion function. However, the embodiment is not limited to this example, and the information search device 1 may optimize the conversion matrix W and the parameter a₁, a₂, b₁, and b₂ of the conversion function using an arbitrary technique.

For example, when the conversion matrix W and the parameter a₁, a₂, b₁, and b₂ of the conversion function are optimized such that the upper limit of the evaluation function is decreased, the information search device 1 decreases the evaluation value of the conversion function when the Hamming distance between the feature quantity vectors of the same user is a predetermined value or less. In other words, the information search device 1 optimizes the conversion matrix W and the parameter a₁, a₂, b₁, and b₂ of the conversion function by decreasing the evaluation value on the conversion function of more appropriately converting a feature quantity vector into a symbol string. However, for example, the information search device 1 may employ the conversion function when the evaluation value of the conversion function of more appropriately converting a feature quantity vector into a symbol string is increased and thus exceeds a predetermined threshold value.

(2) Regarding Evaluation of Conversion Function

At the time of evaluation of the conversion function, the above-described information search device 1 extracts two feature quantity vectors from the feature quantity vector storage unit 10, regards one of the extracted two feature quantity vectors as query data and the other as the registered feature quantity vector, and evaluates the conversion function. However, the embodiment is not limited to this example. For example, the information search device 1 may extract a plurality of feature quantity vectors, regard one of the extracted feature quantity vectors as query data and the remaining feature quantity vectors as the registered feature quantity vectors, and evaluate the conversion function.

(3) Regarding Embodiment of Invention

The above-described information search device 1 extracts candidates of feature quantity vectors positioned near a feature quantity vector of equerry data based on the Hamming distance, and determines whether or not data similar to the feature vector of the query data is present among the candidates of the extracted feature quantity vectors. However, the embodiment of the present invention is not limited to this example.

In other words, the determination on whether or not data similar to query data is present can be made by the information search device according to the related art. In this regard, the present invention may be implemented as an information converting program or an information conversion device that converts a registered feature quantity vector into a symbol string including a wild card symbol “*” and a binary symbol, and search of a feature quantity vector may be undertaken by the information search device according to the related art. In the case of this embodiment, the information search device according to the related art treats “0” as the Hamming distance between the wild card symbol and the binary symbol.

Further, the information search device 1 transmits information about whether or not data similar to a feature vector of query data is present to the client device 2. However, the embodiment is not limited to this example. For example, the information search device 1 may extract a candidate of a feature quantity vector positioned near a feature quantity vector of query data using a Hamming distance, and may transmit the extracted feature quantity vector to the client device 2. Alternatively, the information search device 1 may transmit a feature quantity vector, which is a source of a symbol string that causes a Hamming distance from a binary string of a feature quantity vector of query data to be a predetermined threshold value or less, to the client device 2. Further, the information search device 1 may transmit feature quantity vectors to the client device 2 in the ascending order of Hamming distances.

(4) Regarding Feature Quantity Vector

The above-described information search device 1 stores a feature quantity vector of biological data. However, the embodiment is not limited to this example, and the information search device 1 may store a feature quantity vector on arbitrary information and determine whether or not a feature quantity vector similar to a feature quantity vector of query data remains stored.

(5) Program

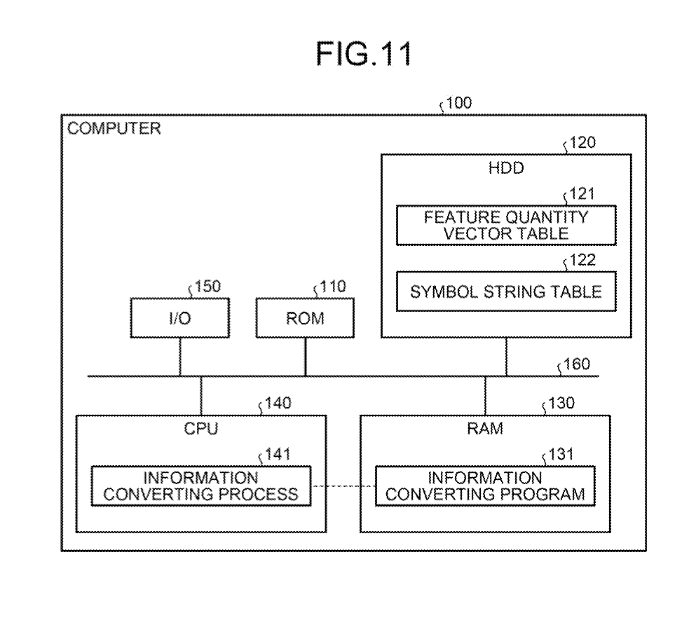

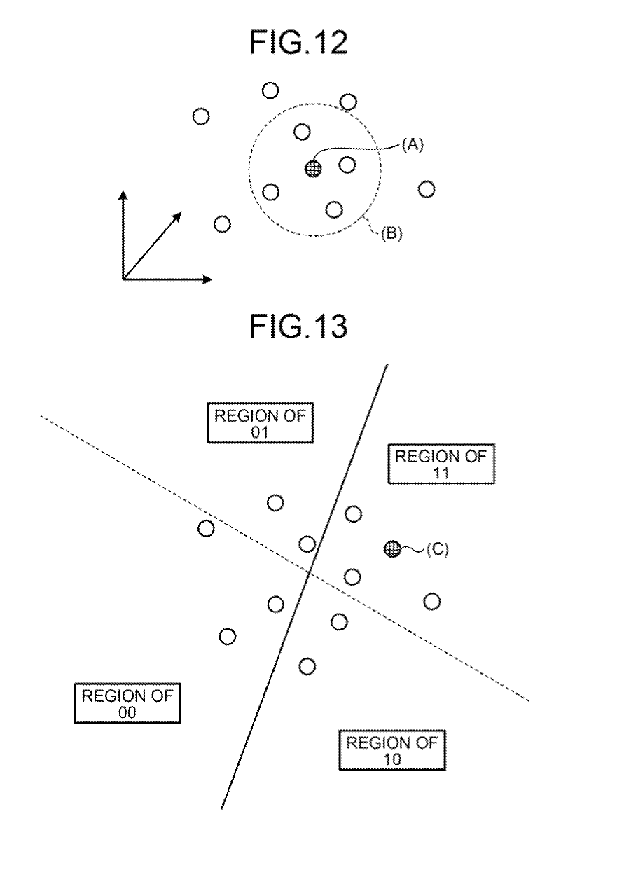

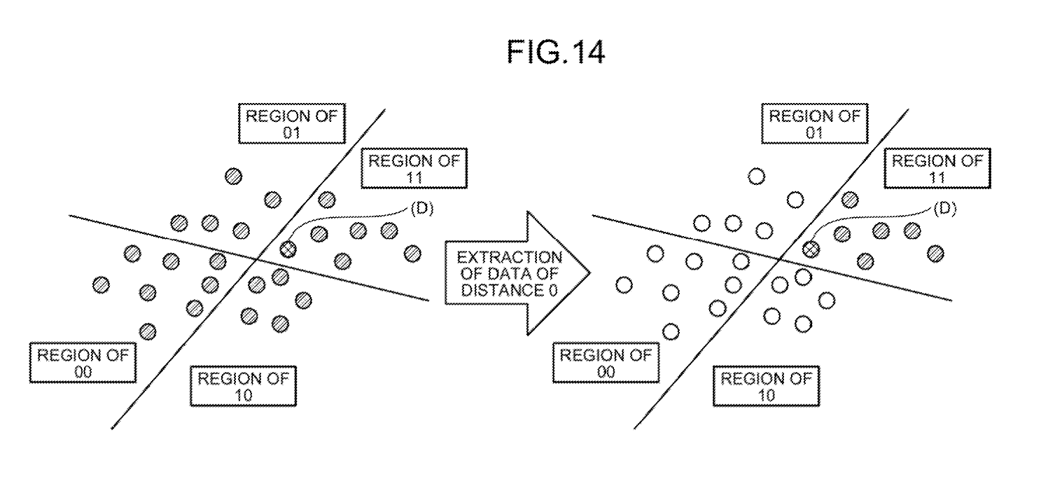

Meanwhile, the information search device 1 according to the first embodiment has been described in connection with the example in which various kinds of processes are implemented using hardware. However, the embodiment is not limited to this example and may be implemented such that a previously prepared program is executed by a computer included in the information search device 1. In this regard, an example of a computer that executes a program having the same function as the information search device 1 according to the first embodiment will be described with reference to FIG. 11. FIG. 11 is a diagram for describing an example of a computer that executes an information converting program.

A computer 100 illustrated in FIG. 11 includes a read only memory (ROM) 110, a hard disk drive (HDD) 120, a random access memory (RAM) 130, and a central processing unit (CPU) 140, which are connected to one another via a bus 160. The computer 100 illustrated in FIG. 11 further includes an input/output (I/O) 150 that transmits or receives a packet.

The HDD 120 stores a feature quantity vector table 121 in which the same information as the information stored in the feature quantity vector storage unit 10 is stored and a symbol string table 122 in which the same information as the information stored in the symbol string data index storage unit 11 is stored. Further, an information converting program 131 is stored in the RAM 130 in advance. In the example illustrated in FIG. 11, as the CPU 140 reads the information converting program 131 from the RAM 130 and executes the information converting program 131, the information converting program 131 functions as an information converting process 141. The information converting process 141 performs the same functions as the conversion function learning unit 12, the feature quantity converting unit 13, and the search unit 14, which are illustrated in FIG. 1.

The information converting program described in the present embodiment may be implemented such that a previously prepared program is executed by a computer such as a personal computer or a workstation. The program may be distributed via a network such as the Internet. Further, the program may be stored in a computer readable recording medium such as a hard disk, a flexible disk (FD), a compact disc read only memory (CD-ROM), a magneto optical disc (MO), or a digital versatile disc (DVD). Furthermore, the program may be read from a recording medium and executed by a computer.

According to an aspect of the present invention, the accuracy of search when a feature quantity vector is converted into a binary string is improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information conversion device comprising:
a memory; and
a processor coupled to the memory, wherein the processor executes a process comprising converting a feature quantity vector of data which is a target of a search process using a Hamming distance into a symbol string including a binary symbol and a wild card symbol that causes a Hamming distance from the binary symbol to be zero (0).

2. The information conversion device according to claim 1,
wherein the converting includes converting the feature quantity vector into the symbol string such that when a certain component of the feature quantity vector of the data which is the target of the search process using the Hamming distance falls within a predetermined range from a boundary with a feature quantity vector of a different class, the certain component is converted into the wild card symbol that causes the Hamming distance from the binary symbol to be zero (0), and when the certain component of the feature quantity vector of the data which is the target of the search process using the Hamming distance does not fall within the predetermined range from the boundary with the feature quantity vector of the different class, the certain component is converted into a binary symbol.

3. The information conversion device according to claim 1,
wherein the converting includes calculating a product of a predetermined conversion matrix and the feature quantity vector, and
converting the feature quantity vector into the symbol string such that when a certain component of the calculated product is included in a predetermined range, the certain component is converted into the wild card symbol, and when the component is not included in the predetermined range, the certain component is converted into a binary symbol corresponding to a value of the component.

4. The information conversion device according to claim 1,
wherein the process further comprises:
extracting a plurality of pieces of data from the data which is a target of a search process using a Hamming distance;
evaluating a predetermined conversion function based on a distance between feature quantity vectors of the data extracted at the extracting and a Hamming distance between symbol strings obtained by converting the feature quantity vectors by the predetermined conversion function; and
optimizing a parameter of the predetermined conversion function based on evaluation at the evaluating,
wherein the converting includes converting the feature quantity vector of the data into the symbol string using a conversion function having the parameter optimized at the optimizing.

5. The information conversion device according to claim 4,
wherein the evaluating includes decreasing an evaluation value of the conversion function, when the data extracted at the extracting belongs to the same class and the Hamming distance between the symbol strings converted from the data extracted at the extracting is a predetermined value or less, or when the data extracted at the extracting belongs to different classes and the Hamming distance between the symbol strings converted from the data extracted at the extracting is the predetermined value or more, and
the optimizing includes optimizes the parameter such that an upper limit of the evaluation value is decreased.

6. The information conversion device according to claim 1,
Wherein the process further comprises:
storing the data in association with a symbol string converted from the feature quantity vector of the data at the converting; and
searching data associated with a symbol string that a Hamming distance from a binary string converted from query data is a predetermined value or less from among data stored at the storing.

7. An information search device comprising:
a memory; and
a processor coupled to the memory, wherein the processor executes a process comprising:
converting a feature quantity vector of data which is a target of a search process using a Hamming distance into a symbol string including a binary symbol and a wild card symbol that causes a Hamming distance from the binary symbol to be zero (0); and
searching data that causes a Hamming distance between a symbol string converted at the converting and a binary string converted from query data is a predetermined value or less from among the data.

8. An information conversion method comprising executing, by an information conversion device that manages data which is a target of a search process using a Hamming distance, a process of converting a feature quantity vector of the data into a symbol string including a binary symbol and a wild card symbol that causes a Hamming distance from the binary symbol to be zero (0), using a processor.

9. The information conversion method according to claim 8,
wherein the converting includes converting the feature quantity vector into the symbol string such that when a certain component of the feature quantity vector of the data which is the target of the search process using the Hamming distance falls within a predetermined range from a boundary with a feature quantity vector of a different class, the certain component is converted into the wild card symbol that causes the Hamming distance from the binary symbol to be zero (0), and when the certain component of the feature quantity vector of the data which is the target of the search process using the Hamming distance does not fall within the predetermined range from the boundary with the feature quantity vector of the different class, the certain component is converted into a binary symbol.

10. The information conversion method according to claim 8,
wherein the converting includes calculating a product of a predetermined conversion matrix and the feature quantity vector, and
converting the feature quantity vector into the symbol string such that when a certain component of the calculated product is included in a predetermined range, the certain component is converted into the wild card symbol, and when the component is not included in the predetermined range, the certain component is converted into a binary symbol corresponding to a value of the component.

11. The information conversion method according to claim 8,
wherein the process further comprises:
extracting a plurality of pieces of data from the data which is a target of a search process using a Hamming distance;
evaluating a predetermined conversion function based on a distance between feature quantity vectors of the data extracted at the extracting and a Hamming distance between symbol strings obtained by converting the feature quantity vectors by the predetermined conversion function; and
optimizing a parameter of the predetermined conversion function based on evaluation at the evaluating,
wherein the converting includes converting the feature quantity vector of the data into the symbol string using a conversion function having the parameter optimized at the optimizing.

12. The information conversion method according to claim 11,
wherein the evaluating includes decreasing an evaluation value of the conversion function, when the data extracted at the extracting belongs to the same class and the Hamming distance between the symbol strings converted from the data extracted at the extracting is a predetermined value or less, or when the data extracted at the extracting belongs to different classes and the Hamming distance between the symbol strings converted from the data extracted at the extracting is the predetermined value or more, and
the optimizing includes optimizes the parameter such that an upper limit of the evaluation value is decreased.

13. The information conversion method according to claim 8,
wherein the process further comprises:
storing the data in association with a symbol string converted from the feature quantity vector of the data at the converting; and
searching data associated with a symbol string that a Hamming distance from a binary string converted from query data is a predetermined value or less from among data stored at the storing.

14. An information search method comprising:
converting a feature quantity vector of data which is a target of the search process into a symbol string including a binary symbol and a wild card symbol that causes a Hamming distance from the binary symbol to be zero (0), using a processor; and
searching data that causes a Hamming distance between the converted symbol string and a binary string converted from query data is a predetermined value or less, using the processor.

15. A computer-readable recording medium having stored therein a program for causing a computer to execute an information conversion process comprising converting a feature quantity vector of data which is a target of a search process using a Hamming distance into a symbol string including a binary symbol and a wild card symbol that causes a Hamming distance from the binary symbol to be zero (0).

16. A computer-readable recording medium having stored therein a program for causing a computer to execute an information search process comprising:
converting a feature quantity vector of data which is a target of the search process into a symbol string including a binary symbol and a wild card symbol that causes a Hamming distance from the binary symbol to be zero (0); and
searching data that causes a Hamming distance between the converted symbol string and a binary string converted from query data is a predetermined value or less.
